(19) United States
(12) Patent Application Publication
(10) Pub. No.: US 2003/0234820 A1
(43) Pub. Date: Dec. 25, 2003

(54) Method and apparatus for controlling a display unit

(75) Inventor: Byung-Kwon Jeon, Yongin-si (KR)

Correspondence Address: STAAS & HALSEY LLP, SUITE 700, 1201 NEW YORK AVENUE, N.W., WASHINGTON, DC, 20005, US

(73) Assignee: SAMSUNG Electronics Co., Ltd., Suwon-city (KR)

(21) Appl. No.: 10/464,771

(22) Filed: Jun. 19, 2003

(30) Foreign Application Priority Data
Jun. 19, 2002 (KR) 2002-34294

(51) Int. Cl. G09G 5/00

(52) U.S. Cl. 345/810

(57) ABSTRACT

A method and an apparatus for controlling a display unit. The method controls a display unit having a first serial port that is connected to a personal computer having a second serial port. The first serial port is connected to the second serial port via a cable. A menu of the display unit is controlled using the personal computer.

### CROSS-REFERENCE TO RELATED APPLICATIONS

This application claims the priority of Korean Patent Application No. 2002-34294 filed on Jun. 19, 2002 in the Korean Intellectual Property Office, the disclosure of which is incorporated herein in its entirety by reference.

### BACKGROUND OF THE INVENTION

1. Field of the Invention

The present invention relates to a display unit, and, more particularly, to a method and an apparatus for controlling a display unit.

2. Description of the Related Art

Current liquid crystal display (LCD) display units have a “Menu” button, a “+” or “−” button, and a selection button on the external surface so that a user can control information on the brightness, contrast, or geometry thereof. In a case where a display unit is controlled by physically pressing buttons on its external surface, when the “Menu” button is selected, the maximum number of colors that an image displayed on the screen can have is limited, and the outer appearance of the display unit cannot be designed without the buttons on its external surface. Further, if a display unit of a personal computer cannot be controlled by external buttons, the display unit cannot be controlled in a WINDOWS, DOS, LINUX, UNIX, or Mac OS environment. Thus, the user cannot conveniently and easily control the display unit using a mouse.

### SUMMARY OF THE INVENTION

Accordingly, the invention provides a method of conveniently and easily controlling a display unit, which does not require additional buttons on its external surface to control the display unit, so that costs for manufacturing the display unit can be reduced.

The invention provides an apparatus for performing the display unit controlling method.

Additional aspects and advantages of the invention will be set forth in part in the description which follows and, in part, will be obvious from the description, or may be learned by practice of the invention.

According to an aspect of the present invention, there is provided a method of controlling a display unit having a first serial port that is connected to a personal computer having a second serial port. The first serial port is connected to the second serial port via a cable. A menu of the display unit is controlled using the personal computer.

Also, the method determines whether a user wishes to control the display unit, upon that determination displaying a menu image corresponding to the menu via the display unit, determining an icon selected by the user from the displayed menu image, displaying a controllable image corresponding to the determined icon via the display unit, determining a result that the user chooses in the displayed controllable image as a control value of the selected icon, and transmitting the control value and the selected icon from the personal computer to the display unit via the cable, wherein the display unit controls a display unit function represented by the transmitted icon by the control value.

According to another aspect of the present invention, there is provided an apparatus for controlling a display unit having a first serial port that is connected to a personal computer having a second serial port. The apparatus includes a control checker, a storage unit, a first image outputting unit, an icon identifier, a second outputting unit, a control value identifier, and a transmitter. The control checker checks whether a user wishes to control the display unit and outputs the checked result as a control signal. The storage unit stores a menu image of the display unit and a controllable image corresponding to at least one of the icons marked on the menu image. The first image outputting unit reads the menu image from the storage unit and outputs the menu image to the display unit in response to the control signal. The icon identifier identifies an icon selected by the user from the menu image output from the first image outputting unit and displayed on the display unit and outputs the identified result. The second outputting unit that reads the controllable image corresponding to the identified result from the storage unit and outputs the controllable image to the display unit. The control value identifier identifies a result the user chooses in the controllable image output from the second image outputting unit and displayed on the display unit and outputs the identified result as a control value of the selected icon. The transmitter transmits the identified result input from the icon identifier and the control value input from the control value identifier to the display unit. It is preferable that the first serial port is connected to the second serial port via a cable, and the display unit displays the menu image input from the first image outputting unit and the controllable image input from the second image outputting unit and adjusts a display unit function represented by the icon corresponding to the identified result transmitted from the transmitter by the transmitted control value.

### BRIEF DESCRIPTION OF THE DRAWINGS

These and/or other aspects and advantages of the invention will become apparent and more readily appreciated from the following description of the preferred embodiments taken in conjunction with the accompanying drawings in which:

FIG. 1 is a flowchart explaining a method of controlling a display unit according to an embodiment of the present invention;

FIG. 2 is a view explaining the method of controlling the display unit shown in FIG. 1;

FIG. 3 is a flowchart explaining operation 12 shown in FIG. 1;

FIG. 4 is an exemplary view of a menu image displayed on a display unit;

FIG. 5 is an exemplary view of a controllable image displayed when a geometry icon is confirmed;

FIG. 6 is an exemplary view of a controllable image displayed when a screen icon is confirmed in operation 44; and

FIG. 7 is a block diagram of an apparatus for performing the method of controlling a display unit shown in FIG. 3.

### DETAILED DESCRIPTION OF THE PREFERRED EMBODIMENTS

Reference will now be made in detail to the present preferred embodiments of the present invention, examples of which are illustrated in the accompanying drawings, wherein like reference numerals refer to the like elements throughout. The embodiments are described below in order to explain the present invention by referring to the figures.

An example of the type of display unit controlled by these embodiments of the present invention is a monitor. To assist in explaining the present invention, throughout the description it will be assumed that the display unit is a monitor. However, the present invention is not limited to a monitor.

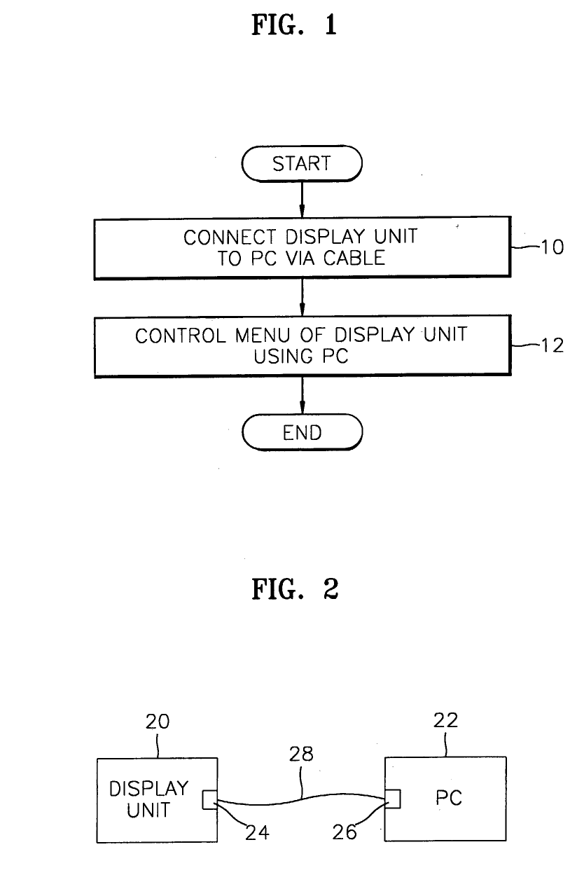

FIG. 1 is a flowchart explaining a method of controlling a display unit according to an embodiment of the present invention. The method comprises operations 10 and 12 of connecting a display unit to a personal computer (PC) via a cable and controlling a menu of the display unit.

FIG. 2 is a view explaining the display unit controlling method shown in FIG. 1. Here, a display unit 20 and a PC 22 are shown.

In the display unit controlling method according to this embodiment of the present invention, as shown in FIG. 2, in operation 10, a first serial port 24 of the display unit 20 is connected to a second serial port 26 of the PC 22 via a cable 28. Here, the display unit 20 generally serves to support the cable 28 regardless of the type of the display unit 20. The display unit 20 may be a cathode ray tube (CRT) display unit or an LCD display unit.

Here, a serial port means a port for communication, such as an RS232 port or a USB (Universal Serial Bus) port. To assist in explaining the present invention, throughout the description it will be assumed that the serial port is an RS232 port. However, the present invention is not limited to an RS232 port.

After operation 10, the PC 22 controls a menu of the display unit 20 in step 12. According to this embodiment of the present invention, the PC 22 can control the menu of the display unit 20 in a WINDOWS, DOS, LINUX, UNIX, or MAC OS environment.

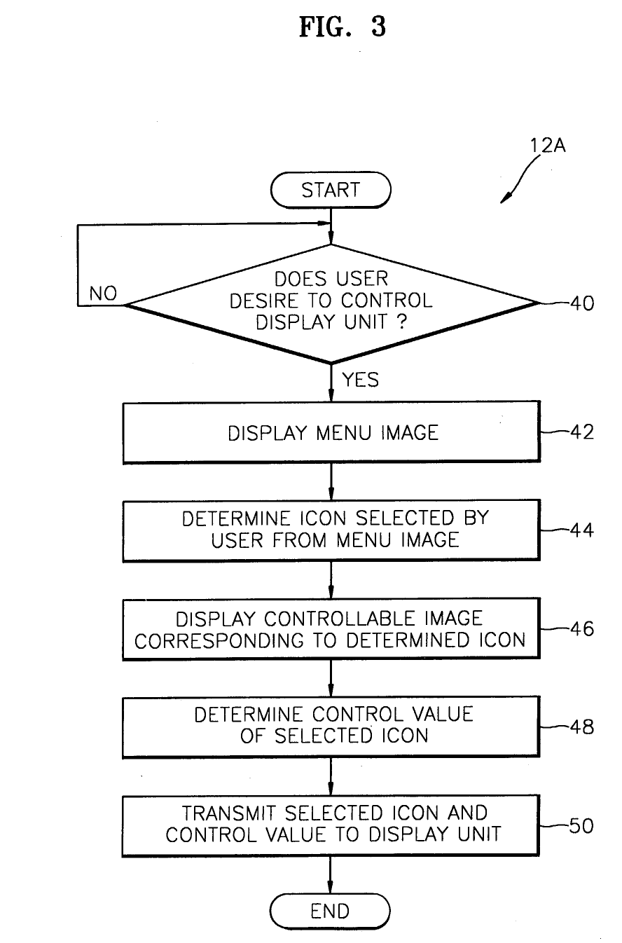

FIG. 3 is a flowchart explaining an aspect 12A of operation 12 shown in FIG. 1. The operation 12A comprises operations 40, 42, and 44 of a user selecting a desired icon from a menu image displayed when the user desires to control the display unit 20, and operations 46, 48, and 50 of calculating a control value of the selected icon and transmitting the control value and the selected icon to the display unit 20.

After operation 10, the PC 22 continues to determine whether the user would like to control the display unit 20 in operation 40.

If the PC 22 determines that the user desires to control the display unit 20, the PC 22 displays the menu image showing the menu of the display unit 20 to the user via the display unit 20 in operation 42. Here, the menu image displayed on the display unit 20 may include geometry icons, position icons, brightness icons, contrast icons, color icons, and the like. The geometry icons are selected so that a screen can be displayed on the display unit 20 as a geometrical, e.g., lozenge-shaped, trapezoid-shaped, or parallelogram-shaped. Also, the position icons are selected to change the position of the screen displayed on the display unit 20, e.g., move the screen in a horizontal direction or a vertical direction. The brightness icons are selected to brighten or darken the screen displayed on the display unit 20. The contrast icons are selected to increase or decrease the contrast of the screen displayed on the display unit 20. The color icons are selected to adjust the color of the screen displayed on the display unit 20.

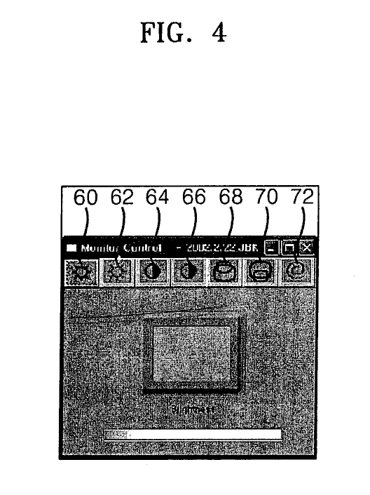

FIG. 4 is an exemplary view of a menu image displayed on the display unit 20. The menu image include a brightness increase icon 60, a brightness decrease icon 62, a contrast increase icon 64, a contrast decrease icon 66, a position upward icon 68, a position downward icon 70, and a standard control icon 72.

Here, the position upward icon 68 and the position downward icon 70 correspond to the previously described position icons. The standard control icon 72 is selected to automatically set brightness, contrast, and colors of the screen displayed on the display unit 20 to predetermined values.

If it is determined that the user would like to control the display unit 20 in the display unit controlling method according to an embodiment of the present invention, for example, the menu image as shown in FIG. 4 may be displayed to the user in operation 42.

After operation 42, in operation 44, the PC 22 determines the icon selected by the user from the menu image displayed on the display unit 20. In other words, if the user selects a desired icon from the displayed menu image, the icon that has been selected is confirmed in the display unit controlling method according to this embodiment of the present invention. Here, the user can select a desired icon from the displayed menu image using a mouse (not shown). More particularly, the user can move the mouse's position indicator to the desired icon, and select the desired icon by clicking the mouse button.

After operation 44, the PC 22 displays a controllable image corresponding to the confirmed icon to the user via the display unit 20 in operation 46.

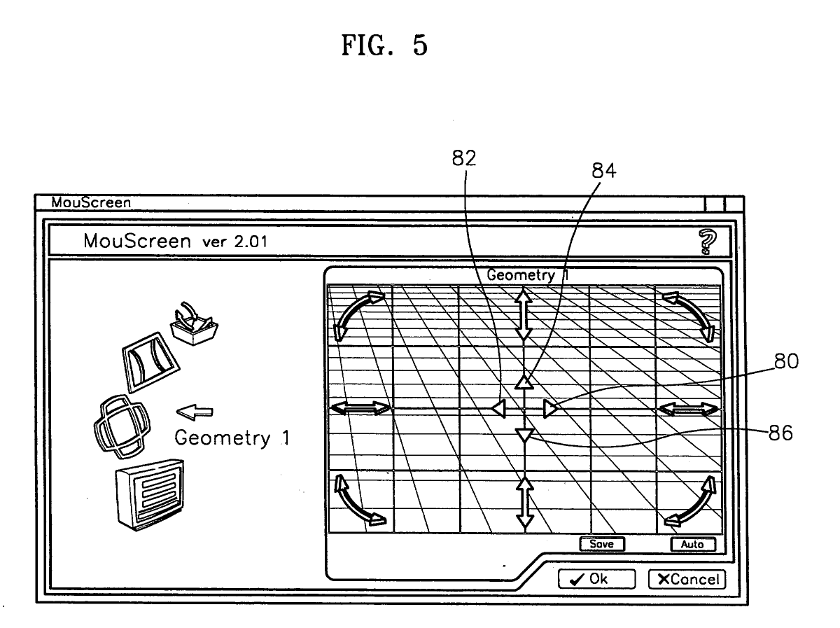

FIG. 5 is an exemplary view of a controllable image displayed when a confirmed icon is a geometry icon. The controllable image has a plurality of progress bars 80, 82, 84, and 86.

If the user selects the geometry icon from the menu image in the display unit controlling method according to this embodiment of the present invention, for example, the controllable image as shown in FIG. 5 is displayed to the user via the display unit 20 in operation 46.

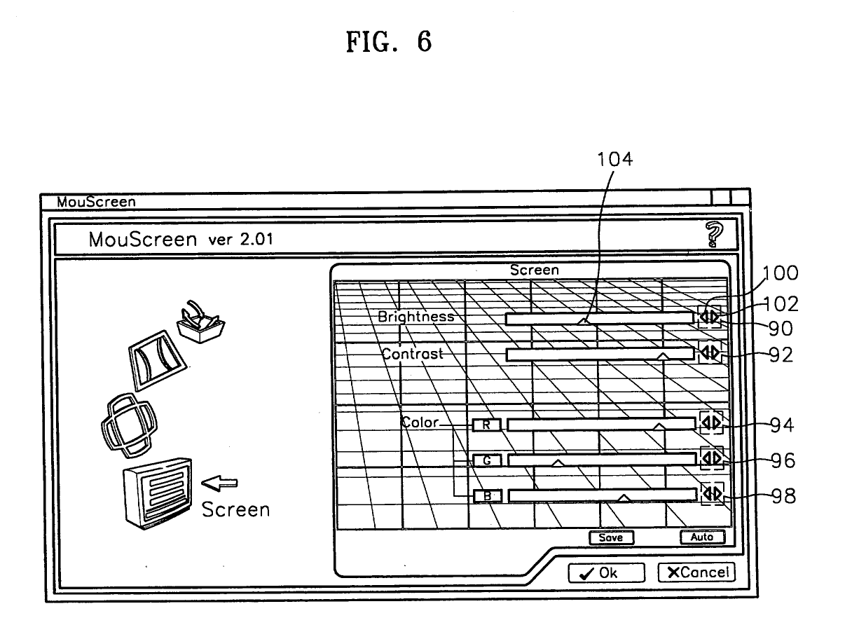

FIG. 6 is an exemplary view of a controllable image displayed when the icon confirmed in operation 44 is a screen icon. The controllable image has a plurality of progress bars 90, 92, 94, 96, and 98. Here, the screen icon includes a brightness icon, a contrast icon, and a color icon. The color icon has progress bars 94, 96, and 98 corresponding to red R, green G, and blue B.

After operation 46, the result that the user chooses in the displayed controllable image is determined as a control value of the selected icon. For example, when the controllable image shown in FIG. 5 or 6 is displayed, the user manipulates the progress bar 80, 82, 84, 86, 90, 92, 94, 96, or 98 using a mouse or the like. Then, a control value of a corresponding icon is determined.

After operation 48, the control value and the selected icon are transmitted from the PC 22 to the display unit 20 via the cable 28 in step 50. Here, the display unit 20 controls the icon received from the PC 22 by the control value. For example, if the user clicks on a left bar 100 of the progress bar 90 using the mouse to control the brightness icon, a pointer 104 moves to the left and the controllable image darkens. If the user clicks on a right bar 102, the pointer 104 moves to the right and the controllable image brightens. If the user stops clicking on the mouse, a value designated to the position of the pointer 104 is determined as a control value of the brightness icon.

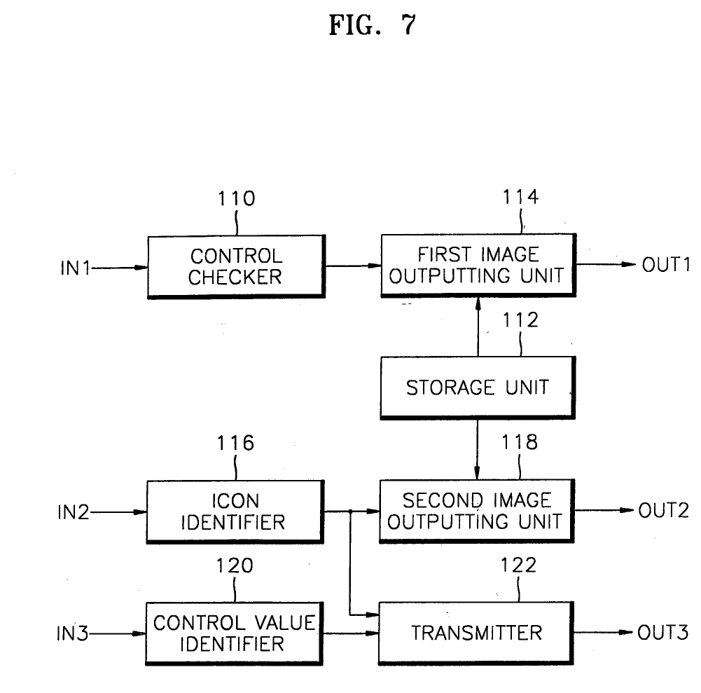

Hereinafter, the structure and operation of an apparatus for performing the display unit controlling method according to an embodiment of the present invention will be described with reference to FIGS. 3 and 7.

FIG. 7 is a block diagram of an apparatus for performing the display unit controlling method according to an embodiment of the present invention described with reference to FIG. 3. The apparatus includes a control checker 110, a storage unit 112, first and second image outputting units 114 and 118, an icon identifier 116, a control value identifier 120, and a transmitter 122.

The apparatus shown in FIG. 7 is included in the PC 22 shown in FIG. 2. Here, to perform operation 40 of FIG. 3, the control checker 110 checks whether the user wishes to control the display unit 20, and outputs the result of the check as a control signal to the first image outputting unit 114. For example, if a display unit control icon indicating that the display unit 20 is to be controlled is displayed on the display unit 20, the user selects the display unit control icon using the mouse or the like to control the display unit 20. In this case, when the user clicks on the display unit control icon using the mouse, the control checker 110 receives a signal via an input port IN1 to indicate that the user wishes to control the display unit 20. Alternatively, an additional key (not shown) representing a display unit control icon may be prepared on a keyboard (not shown) so that the user can press the additional key to control the display unit 20.

To carry out operation 42, the first image outputting unit 114 reads a menu image from the storage unit 112 and outputs the read menu image to the display unit 20 through the cable 28 and via an output port OUT1 in response to the control signal input from the control checker 110. For example, if the first image outputting unit 114 perceives from the control signal that the user wishes to control the display unit 20, the first image outputting unit 114 outputs the menu image read from the storage unit 112 to the display unit 20 via the output port OUT1. For this, the storage unit 112 stores the menu image of the display unit 20. Here, the display unit 20 displays the menu image input from the first image outputting unit 114.

To perform operation 44, the icon identifier 116 identifies an icon selected by the user from the menu image output from the first image outputting unit 114, and displayed on the display unit 20, and then outputs the identified result to the second image outputting unit 118. For example, the user selects a desired icon from the menu image displayed on the display unit 20 using the mouse or the like. In this case, when the user clicks on the desired icon using the mouse, the icon identifier 116 receives a signal via an input port IN2 to identify the icon selected by the user.

To perform operation 46, the second image outputting unit 118 reads a controllable image corresponding to the icon selected by the user, from the storage unit 112 using the identified result input from the icon identifier 116, and then outputs the controllable image to the display unit 20 through the cable 28 and via the output port OUT2. For this, the storage unit 112 stores a controllable image corresponding to at least one of the icons of the menu image displayed on the display unit 20. Here, the display unit 20 displays the controllable image input from the second image outputting unit 118.

To carry out operation 48, the control value identifier 120 identifies the result that the user designates in the controllable image output from the second image outputting unit 118, displayed on the display unit 20, and then outputs to the transmitter 122 the identified result as a control value of the selected icon. For example, the user points a progress bar of a desired icon, e.g., the progress bar 80, 82, 84, 86, 90, 92, 94, 96, or 98, in the controllable image displayed on the display unit 20, e.g., the controllable image shown in FIGS. 5 or 6, using the mouse or the like and adjusts a value of the desired icon to a desired value. In this case, when the user clicks on desired progress bar using the mouse, the control value identifier 120 receives a signal generated by the mouse via an input port IN3 to identify the choice of the user.

To perform operation 50, the transmitter 122 transmits the identified result input from the icon identifier 116, i.e., the icon selected by the user and the control value input from the control value identifier 120, to the display unit 20 via an outpurt port OUT3, and through the cable 28. Here, the display unit 20 adjusts a display unit function corresponding to the identified result transmitted from the transmitter 122 by the transmitted control value.

Alternately, the operations of the apparatus of FIG. 7 could be implemented by permanent or removable digital storage, such as magnetic and optical discs, RAM, ROM, etc., on which the operations and data structures of the present invention can be stored and distributed. The operations can also be distributed via, for example, downloading over a network such as the Internet.

As described above, unlike a conventional display unit controlling method in which a display unit has to include an additional control chip (not shown) capable of supporting USB to connect the display unit to a PC via the USB, in a method and an apparatus for controlling a display unit according to an embodiment of the present invention, a display unit 20 is connected to a PC 22 via a cable 28. Thus, the display unit 20 does not require an additional control chip for supporting the cable 28 so that costs for manufacturing the display unit 20 can be reduced. Also, a user can conveniently and easily control the display unit 20 using a mouse, a scroll bar, or various other functions provided in WINDOWS. In addition, a menu image can be generated without limiting the number of colors. Furthermore, a display unit can be designed without buttons for controlling the display unit so as to meet the trend toward emphasis on a sleek outer appearance, such as an LCD display unit.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A method of controlling a display unit that is connected to a personal computer, the method comprising:
connecting a first serial port of the display unit to a second serial port of the personal computer via a cable; and
controlling a menu of the display unit using the personal computer.

2. The method of claim 1, wherein the controlling of the menu comprises:
determining whether a user wishes to control the display unit;
if determined that the user wishes to control the display unit, displaying a menu image corresponding to the menu via the display unit;
determining an icon selected by the user from the displayed menu image;
displaying a controllable image corresponding to the determined icon via the display unit;
determining a result that the user chooses in the displayed controllable image as a control value of the selected icon; and
transmitting the control value and the selected icon from the personal computer to the display unit via the cable, wherein the display unit controls a display unit function represented by the transmitted icon by the control value.

3. The method of claim 1, wherein the first serial port is an RS232 port, and wherein the second serial port is an RS232 port.

4. The method of claim 2, wherein the user selects the icon using a mouse.

5. The method of claim 2, wherein the user selects the icon using a keyboard.

6. The method of claim 2, wherein the icon to be selected by the user is one icon selected from a plurality of icons, at least one of which represents display unit position, brightness, contrast, or color.

7. The method of claim 2, wherein the controllable image comprises a plurality of adjustable progress bars.

8. The method of claim 7, wherein the user controls sliding indicators on the progress bars, respectively, by selecting right and left directional images.

9. An apparatus for controlling a display unit having a first serial port that is connected to a personal computer having a second serial port, the apparatus comprising:
a control checker that checks whether a user wishes to control the display unit and outputs the checked result as a control signal;
a storage unit that stores a menu image of the display unit and a controllable image corresponding to at least one icon marked on the menu image;
a first image outputting unit that reads the menu image from the storage unit and outputs the menu image to the display unit in response to the control signal;
an icon identifier that identifies the icon selected by the user from the menu image output from the first image outputting unit and displayed on the display unit, and outputs the identified result;
a second outputting unit that reads the controllable image corresponding to the identified result from the storage unit and outputs the controllable image to the display unit;
a control value identifier that identifies a result the user chooses in the controllable image output from the second image outputting unit and displayed on the display unit, and outputs the identified result as a control value of the selected icon;
a transmitter that transmits the identified result input from the icon identifier and the control value input from the control value identifier to the display unit; and
wherein the first serial port is connected to the second serial port via a cable, and the display unit displays the menu image input from the first image outputting unit and the controllable image input from the second image outputting unit and adjusts a display unit function represented by the icon corresponding to the identified result transmitted from the transmitter by the transmitted control value.

10. The apparatus of claim 9, wherein the first serial port is an RS232 port, and wherein the second serial port is an RS232 port.

11. A computer readable storage medium controlling a personal computer with a first serial port, connected to a display unit with a second serial port by a cable, and comprising a process of controlling a menu of the display unit using the personal computer through the serial port.

12. The computer readable storage medium of claim 11, wherein the controlling the menu comprises:
determining whether a user wishes to control the display unit;
if determined that the user wishes to control the display unit, displaying a menu image corresponding to the menu via the display unit;
determining an icon selected by the user from the displayed menu image;
displaying a controllable image corresponding to the determined icon via the display unit;
determining a result that the user chooses in the displayed controllable image as a control value of the selected icon; and
transmitting the control value and the selected icon from the personal computer to the display unit via the cable, wherein the display unit controls a display unit function represented by the transmitted icon by the control value.

13. The computer readable storage medium of claim 11, wherein the first serial port is an RS232 port, and wherein the second serial port is an RS232 port.

14. The computer readable storage medium of claim 12, wherein the user selects the icon using a mouse.

15. The computer readable storage medium of claim 12, wherein the user selects the icon using a keyboard.

16. The computer readable storage medium of claim 12, wherein the icon to be selected by the user is one icon selected from a plurality of icons, at least one of which represents display unit position, brightness, contrast, or color.

17. The computer readable storage medium of claim 12, wherein the controllable image comprises a plurality of adjustable progress bars.

18. The computer readable storage medium of claim 17, wherein the user controls sliding indicators on the progress bars, respectively, by selecting right and left directional images.

19. A method of controlling a display unit that is connected to a personal computer, the method comprising:
connecting a first serial port of the personal computer to a second serial port of the display unit via a cable, wherein a menu of the display unit is controlled using the personal computer, and the menu control is communicated solely through the cable.

20. The method of claim 19, wherein the first serial port is an RS232 port, and wherein the second serial port is an RS232 port.

21. A personal computer usable with a cable, wherein the personal computer controls a display unit through the cable connected to a first serial port of the display unit, comprising:
a second serial port of the personal computer connected to the display unit via the cable, and
wherein the display unit displays a menu image and a controllable image, and adjusts a display unit function corresponding to these images according to control values communicated to the display unit by the computer through the cable.

22. The personal computer of claim 21, wherein the first serial port is an RS232 port, and wherein the second serial port is an RS232 port.

23. A system comprising:
a personal computer having a first serial port;
a display unit having a second serial port; and
a cable connecting the first serial port of the computer with the second serial port of the display unit;
wherein the display unit displays a menu image and a controllable image, and adjusts a display unit function corresponding to these images according to control values communicated to the display unit by the computer through the cable.

24. The system of claim 23, wherein the first serial port is an RS232 port, and wherein the second serial port is an RS232 port.
